(19) United States
(12) Patent Application Publication
(10) Pub. No.: US 2011/0233433 A1
(43) Pub. Date: Sep. 29, 2011

(54) SEALED FLAPPER DIVERTER VALVE

(76) Inventors: John M. Dehais, Windsor, CT (US); Mike T. Burnickas, Westfield, MA (US)

(21) Appl. No.: 12/748,707

(22) Filed: Mar. 29, 2010

(51) Int. Cl. F16K 31/02

(52) U.S. Cl. 251/129.01

(57) ABSTRACT

A valve for use in an aircraft that includes a cabin that requires conditioned air and avionics that may require conditioned air. The valve includes a housing, a single flapper disposed in the housing, a first opening in the housing in proximity to the flapper for carrying conditioned air to the avionics, a second opening in the housing in proximity to the flapper for carrying conditioned air to the cabin, an electromechanical device for moving the flapper from a first position in which air may be vented to the first opening and not the second opening and a second position where air may be ducted to the second opening and not the first opening.

This invention was made with Government support under Contract No. N00019-06-C-0081 awarded by the United States Navy. The Government has certain rights in this invention.

Aircrafts have various heating and cooling requirements relating to both passengers and avionic systems, like control, environmental control (ECS), monitoring, communication, navigation, weather and anti-collision systems, etc. that are used to control the aircraft. Occasionally, the avionics require more cooling than the passengers due to mission requirements, equipment malfunction or the like. In those instances, air that is used to cool a cabin may be diverted from the cabin to the avionics to keep them in an acceptable working range. Continued operation of the avionics may be critical to the aircraft and care must be taken to avoid exposing them to higher temperatures that could damage those systems.

Prior art avionics diverters may use a pair of rotatable valves for diverting flow from the cabin. One of the valves may close the duct to the cabin and the other valve may open the vent to the avionics. In contrast, if the avionics do not need increased cooling, the valves are rotated such that the valve to the avionic duct closes the avionic duct and the valve to the cabin opens the cabin duct.

### SUMMARY OF THE INVENTION

According to an exemplary embodiment, a valve for use in an aircraft that includes a cabin that requires conditioned air and avionics that may require conditioned air. The valve includes a housing, a single flapper disposed in the housing, a first opening in the housing in proximity to the flapper for carrying conditioned air to the avionics, a second opening in the housing in proximity to the flapper for carrying conditioned air to the cabin, an electromechanical device for moving the flapper from a first position in which air may be vented to the first opening and not the second opening and a second position where air may be ducted to the second opening and not the first opening.

According to an exemplary embodiment, a valve for use in an aircraft to divert flow between first environment that requires conditioning and a second environment that may require conditioning has a housing, a single flapper disposed in the housing, a first opening disposed in the housing in proximity to the flapper for carrying conditioned air to the first environment, a second opening disposed in the housing in proximity to the flapper for carrying conditioned air to the second environment, an electromechanical device for moving the flapper from a first position in which air may be vented to the first opening and not the second opening and a second position where air may be ducted to the second opening and not the first opening.

According to an exemplary embodiment, a method for controlling a valve for use in an aircraft that includes a cabin that requires conditioned air and avionics that may require conditioned air. The method includes providing a housing, providing a single flapper disposed in the housing, providing a first opening in the housing in proximity to the flapper for carrying conditioned air to the avionics, providing a second opening in the housing in proximity to the flapper for carrying conditioned air to the cabin, activating an electromechanical device to move the flapper to a first position to vent air to the first opening to condition the avionics if the avionics require conditioning and not to the second opening, and activating an electromechanical device to move the flapper from the first position to a second position to vent air to the second opening to condition the cabin if the avionics do not require conditioning and not to the first opening.

These and other features of the present invention can be best understood from the following specification and drawings, the following of which is a brief description.

### BRIEF DESCRIPTION OF THE DRAWINGS

FIG. 1 is a schematic diagram of heating and cooling air flowing to a cabin.

FIG. 2 is a schematic embodiment of the air flowing to avionics.

FIG. 3 is a perspective view in section of a flapper used to seal either the avionics or the cabin.

FIG. 4 is a perspective end view of the housing and taken along the line 4 of FIG. 3.

### DETAILED DESCRIPTION OF THE PREFERRED EMBODIMENT

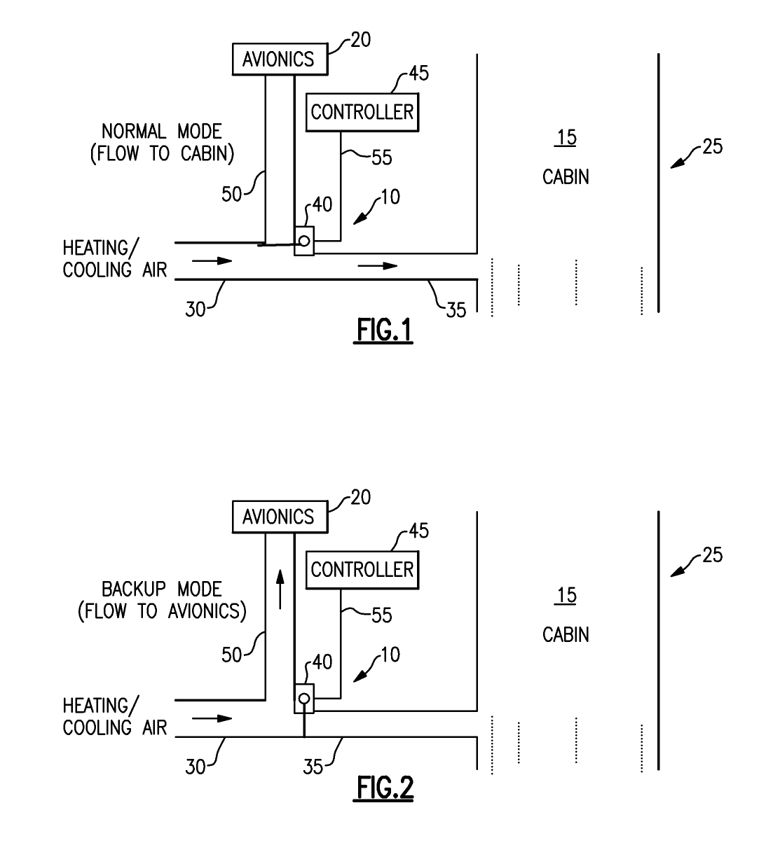

Referring now to FIG. 1, a diverter valve 10 is shown. The diverter valve 10 may heat and cool a cabin 15 or its avionics 20 in a helicopter or other aircraft 25. Heating or cooling air travels through duct 30 from a fan or an inlet particle separator or the like (not shown), by the diverter valve 10, and through duct 35 to provide conditioned air to the cabin 15. A motor 40 controlled by controller 45, which may be part of the avionics 20, is used to provide motive force to the diverter valve 10 as will be discussed herein.

Referring to FIG. 2, the diverter valve 10 is shown in a second position so that heating or cooling air is diverted from the cabin 15 to avionics 20 by shutting duct 35 and opening duct 50. As stated above, a diversion of cooling air may occur if the avionics 20 require more cooling air. Generally the avionics 20 should be kept below 160° F. (71.1 degrees Celsius) or so to maintain a safe operating range. In such a situation, the controller 45 sends a signal to the motor 40 via wire 55 to move the diverter valve 10 to close off duct 35 and open duct 50 to allow flow through duct 50 to the avionics 20 to cool them.

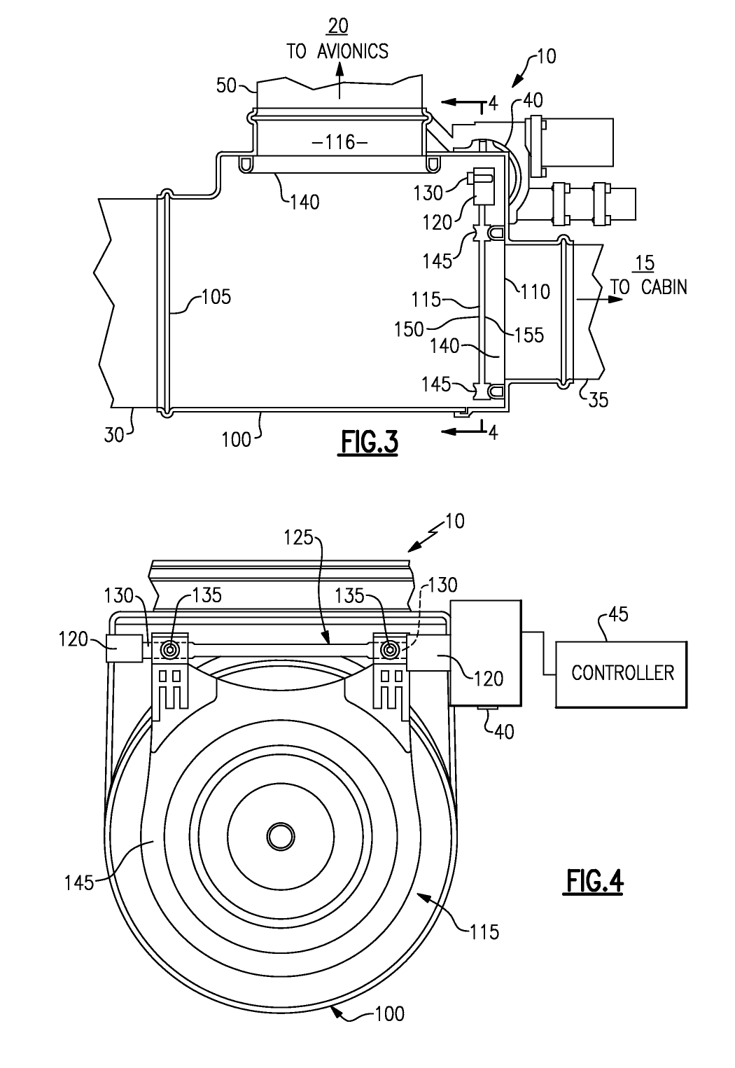

Referring now to FIGS. 3 and 4, the diverter valve 10 is shown. The diverter valve 10 has a housing 100 having an inlet 105 receiving air from duct 30, an outlet opening 110 (or opening 110) for attaching to duct 35 to vent air to the cabin 15, an outlet opening 116 (or opening 116) attaching to duct 50 to vent air to the avionics 20, a flapper 115 that seals air from entering the avionics duct 50 and the cabin duct 35, a bushing 120 attaching the flapper 115 to a shaft 125 and a motor 40 driving the shaft 125 to open and close the ducts 35, 50. The bushings 120 include an opening 130 for receiving the shaft 125, set screws 135 attaches the flapper 115 to the shaft 125 as is known in the art.

A seal 140 having a d-shaped cross section encircle each duct 35, 50. The flapper 115 is circular to match the shape of the seals 140 (though other shapes are contemplated herein), though slightly bigger, and has a curved, circular land 145 on its inner and outer sides 150, 155 that extends beyond the seals 140 so that any sharp edges of the flapper 115 do not contact the seals 140 and therefore do not abrade them. The land 145 is on both sides 150, 155 of the flapper 115 so it can contact the seal 140 outside duct 35 and the seal 140 outside duct 50. The ducts 50 and 35 and the seals 140 are placed symmetrically to each other relative to the flapper 115 so that rotation of the flapper 115 lands the flapper 115 on the same place on either seal 140.

The motor 40 is a bi-directional so that it can move the flapper 115 to seal one duct 35 or the other duct 50. Other types of electromechanical and motive devices may also be used to move the flapper 115 and are contemplated herein.

Because the flapper 115 mates well with seals 140, there is very little to no leakage therethrough. Because there is a constant desire in an aircraft to decrease the weight of the aircraft, every ounce of air diverted from an engine should be used properly to ensure that the aircraft can meet its mission goals. If there is leakage through the flapper 115 when in contact with either seal 140 the aircraft may not be able to meet its goals in terms of performance or weight.

In normal operation, air is sent via duct 35 to the cabin 15. The flapper 115 seals any air from flowing to avionics 20 through duct 50. In conditions where the avionics 20 may overheat, controller 45 instructs the motor 40 to move the flapper 115 from sealing the duct 50 to sealing the duct 35, blocking flow to the cabin 15. Air is then directed to the avionics 20 via duct 50 until the avionics 20 are cool enough to allow cooling flow back to the cabin 15.

The motor 40 that drives the flapper 115 from one position to another operates up to about 130 inch pounds (14.69 Newton meters) of torque to overcome the volume flow of the air flow passing through the duct 30 into the housing 100 if moving from closed duct 35 to closing duct 50. Some of that volume force is offset by the flexible nature of the material used in the flapper 115 to allow the motor 40 to overcome that flow without stalling. The flapper 115 is constructed of PEEK (e.g., polyetheretherketone), or a similar material which is light, flexible and compatible with the sealing requirements in this application.

By switching to a single flapper 115, the weight of the aircraft 25 is minimized because two flappers are no longer required.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A valve for use in an aircraft comprising a cabin and avionics, said valve comprising:
a single flapper disposed in a housing, said housing comprising a first opening in proximity to said flapper for carrying conditioned air to said avionics and a second opening in proximity to said flapper for carrying said conditioned air to said cabin, and
an electromechanical device for moving said flapper between a first position to vent said conditioned air to said first opening and not said second opening and a second position to duct said conditioned air to said second opening and not said first opening.

2. The valve of claim 1 wherein said first opening and said second opening are located relative to said flapper such that a first side of said flapper seals said first opening when said flapper is at said second position and a second side of said flapper seals said second opening when said flapper is at said first position.

3. The valve of claim 2 wherein said first opening and said second opening are placed symmetrically relative to said flapper.

4. The valve of claim 1 wherein said electromechanical device seals said second opening if a temperature of said avionics approaches 160° F.

5. The valve of claim 1 wherein each of said openings is encircled by a seal.

6. The valve of claim 5 wherein said flapper has a curved land thereon for cooperating with one or more of said seals such that said seals are not abraded.

7. The valve of claim 6 wherein said curved land extends beyond said seal.

8. The valve of claim 6 wherein said flapper has said curved land on both sides thereof

9. A valve for use in an aircraft to divert flow between first environment that requires conditioning and a second environment that conditionally requires conditioning, said valve comprising:
a housing,
a single flapper disposed in said housing,
a first opening disposed in said housing in proximity to said flapper for carrying conditioned air to said first environment,
a second opening disposed in said housing in proximity to said flapper for carrying said conditioned air to said second environment, and
an electromechanical device for conditionally moving said flapper between a first position to vent said conditioned air to said first opening and not said second opening and a second position to duct said conditioned air to said second opening and not said first opening.

10. The valve of claim 9 wherein said first opening and said second opening are located relative to said flapper such that a first side of said flapper seals said first opening when said flapper is at said second position and a second side of said flapper seals said second opening when said flapper is at said first position.

11. The valve of claim 10 wherein said first opening and said second opening are placed symmetrically relative to said flapper.

12. The valve of claim 9 wherein said electromechanical device seals said second opening if a temperature of said second environment approaches 160° F.

13. The valve of claim 9 wherein each of said openings is encircled by a seal.

14. The valve of claim 13 wherein said flapper has a curved land thereon for cooperating with one or more of said seals such that said seals are not abraded.

15. The valve of claim 14 wherein said curved land extends beyond said seal.

16. The valve of claim 14 wherein said flapper has said curved land on both sides thereof.

17. A method for controlling a valve for use in an aircraft comprising a cabin and avionics, said method comprising:
providing a housing,
providing a single flapper disposed in said housing,
providing a first opening in said housing in proximity to said flapper for carrying conditioned air to said avionics,
providing a second opening in said housing in proximity to said flapper for carrying said conditioned air to said cabin,
activating an electromechanical device to move said flapper to a first position to vent said conditioned air to said first opening to condition said avionics if said avionics require conditioning and not to said second opening, and
activating said electromechanical device to move said flapper from said first position to a second position to vent said conditioned air to said second opening to condition said cabin if said avionics do not require conditioning and not to said first opening.
